(19) United States
(12) Patent Application Publication
(10) Pub. No.: US 2025/0158021 A1
(43) Pub. Date: May 15, 2025

(54) NEGATIVE ELECTRODE ACTIVE MATERIAL AND RECHARGEABLE LITHIUM BATTERY INCLUDING SAME

(71) Applicants: SAMSUNG SDI CO., LTD., Yongin-si (KR); Research & Business Foundation SUNGKYUNKWAN UNIVERSITY, Suwon-si (KR)

(72) Inventors: Jaewon KIM, Yongin-si (KR); Young-Min KIM, Yongin-si (KR); Youngugk KIM, Yongin-si (KR); Eunji KANG, Yongin-si (KR); Deok-Hyun KIM, Yongin-si (KR); Hyejin KIM, Yongin-si (KR); Sunil PARK, Yongin-si (KR); llyoung CHOI, Yongin-si (KR); Doori OH, Yongin-si (KR); Narae KIM, Yongin-si (KR); Yookyung KIM, Yongin-si (KR); Young-Jun KIM, Suwon-si (KR); Junmyoung SHEEM, Suwon-si (KR)

(21) Appl. No.: 18/650,273

(22) Filed: Apr. 30, 2024

(30) Foreign Application Priority Data
Nov. 9, 2023 (KR) 10-2023-0154681

(51) Int. Cl. H01M 4/36; H01M 4/02; H01M 4/04; H01M 4/38; H01M 4/583; H01M 4/62; H01M 10/0525

(52) U.S. Cl. CPC H01M 4/364; H01M 4/0471; H01M 4/366; H01M 4/386; H01M 4/583; H01M 4/625; H01M 10/0525; H01M 2004/021; H01M 2004/027

(57) ABSTRACT

A negative electrode active material includes a core including a silicon-carbon composite; and a coating layer on a surface of the core, the coating layer including a surfactant and graphene, wherein the negative electrode active material has a ratio (I_{second peak}/I_{first peak}) of an intensity of a second peak appearing at 2θ=about 45° to about 50° relative to an intensity of a first peak appearing at 2θ=about 25° to about 27° of about 0.1 to about 0.4, in an X-ray diffraction analysis using a CuKα ray.

### CROSS-REFERENCE TO RELATED APPLICATION

This application claims priority to and the benefit of Korean Patent Application No. 10-2023-0154681 filed in the Korean Intellectual Property Office on Nov. 9, 2023, the entire contents of which are incorporated herein by reference.

### BACKGROUND

### 1. Field

Embodiments relate to a negative electrode active material and a rechargeable lithium battery including the same.

### 2. Description of the Related Art

Recently, the rapid supplement of electronic devices such as mobile phones, laptop computers, and electric vehicles using batteries require surprising increases in demand for rechargeable batteries with relatively high capacity and lighter weight. Research and development for improving the performance of rechargeable lithium batteries are actively studied.

Rechargeable lithium batteries may include a positive electrode and a negative electrode which include active material being capable of intercalating and deintercalating lithium ions, and an electrolyte, and may generate electrical energy due to the oxidation and reduction reaction when lithium ions are intercalated and deintercalated into the positive electrode and the negative electrode.

### SUMMARY

The embodiments may be realized by providing a negative electrode active material including a core including a silicon-carbon composite; and a coating layer on a surface of the core, the coating layer including a surfactant and graphene, wherein the negative electrode active material has a ratio (I_{second peak}/I_{first peak}) of an intensity of a second peak appearing at 2θ=about 45° to about 50° relative to an intensity of a first peak appearing at 2θ=about 25° to about 27° of about 0.1 to about 0.4, in an X-ray diffraction analysis using a CuKα ray.

The I_{second peak}/I_{first peak} may be about 0.2 to about 0.3.

The surfactant may be included in an amount of about 0.005 wt % to 1.05 wt %, based on a total weight of the negative electrode active material.

The graphene may be included in an amount of about 1 wt % to about 10 wt %, based on a total weight of the negative electrode active material.

A specific surface area of the negative electrode active material may be about 130% or less of a specific surface area of the core.

A specific surface area of the negative electrode active material may be greater than about 100% and about 130% or less of a specific surface area of the core.

The silicon-carbon composite may have a porous structure.

The silicon-carbon composite may include nano silicon and amorphous carbon.

A mixing ratio of the nano silicon and the amorphous carbon may be about 70:30 to about 40:60 by weight.

The surfactant may include a cation surfactant.

The surfactant may include dialkyldimethylammonium chloride, benzyldimethylammonium chloride, cetyltrimethylammonium bromide, N-methoxy (polyethylene glycol)-1,2-distearoyl-sn-glycero-3-phosphoethanolamine, or a combination thereof.

The negative electrode active material may be prepared by mixing the silicon-carbon composite, the graphene, and the surfactant to prepare a mixture, and heat-treating the mixture.

The heat-treating may be performed at about 600° C. to about 1,000° C.

The negative electrode active material may be prepared by mixing the graphene and the surfactant in a solvent to prepare a graphene mixed liquid, coating the silicon-carbon composite with the graphene mixed liquid to prepare a coated product, and heat-treating the coated product.

The coating may be performed 1 to 5 times.

The heat-treating may be performed at about 600° C. to about 1,000° C.

The embodiments may be realized by providing a rechargeable lithium battery including a negative electrode including the negative electrode active material according to an embodiment; a positive electrode including a positive electrode active material; and a non-aqueous electrolyte.

The negative electrode may include the negative electrode active material as a first negative electrode active material and further includes crystalline carbon as a second negative electrode active material.

The embodiments may be realized by providing a method of preparing the negative electrode active material according to an embodiment, the method including mixing the silicon-carbon composite, the graphene, and the surfactant to prepare a mixture, and heat-treating the mixture.

The embodiments may be realized by providing a method of preparing the negative electrode active material according to an embodiment, the method including mixing the graphene and the surfactant in a solvent to prepare a graphene mixed liquid, coating the silicon-carbon composite with the graphene mixed liquid to prepare a coated product, and heat-treating the coated product.

### BRIEF DESCRIPTION OF THE DRAWINGS

Features will be apparent to those of skill in the art by describing in detail exemplary embodiments with reference to the attached drawings in which:

FIG. 1 to FIG. 4 are schematic views illustrating a rechargeable lithium battery according to one or more embodiments.

FIG. 5 is a SEM image of the negative electrode active material of Comparative Example 1.

FIG. 6 is a SEM image of the negative electrode active materials of Examples 1 to 4.

FIG. 7 is a graph showing an X-ray diffraction peak measurement for the negative electrode active material of Examples 1 to 4, and Comparative Examples 1 and 3.

FIG. 8 is a graph showing the powder conductivity of the negative electrode active material of Example 1, and Comparative Examples 1 and 2.

FIG. 9 is a graph showing capacity retention of the half-cells according to Examples 1 to 4 and Comparative Example 1.

FIG. 10 is a graph showing the high-rate characteristics of the half-cells according to Examples 1 to 4 and Comparative Example 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. In addition, it will also be understood that when a layer is referred to as being “between” two layers, it can be the only layer between the two layers, or one or more intervening layers may also be present. Like reference numerals refer to like elements throughout.

As used herein, when a definition is not otherwise provided, it will be understood that when an element such as a layer, film, region, or substrate is referred to as being “on” another element, it may be directly on the other element or intervening elements may also be present.

Unless otherwise specified in the specification, expressions in the singular include expressions in plural. Unless otherwise specified, “A or B” may indicate “includes A, includes B, or includes A and B”.

As used herein, the term “combination thereof” may include a mixture, a laminate, a complex, a copolymer, an alloy, a blend, a reactant of constituents.

As used herein, when a definition is not otherwise provided, a particle diameter may be an average particle diameter. Such a particle diameter indicates an average particle diameter (D50) where a cumulative volume is about 50 volume % in a particle size distribution. The particle size (D50) may be measured by a method well known to those skilled in the art, for example, by a particle size analyzer, or by a transmission electron microscopic image, or a scanning electron microscopic image. In some embodiments, a dynamic light-scattering measurement device is used to perform a data analysis, and the number of particles is counted for each particle size range, and from this, the average particle diameter (D50) value may be easily obtained through a calculation. The particle size may be measured by a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of about 60 W, and calculating an average particle diameter (D50) in the 50% standard of particle distribution in the measuring device.

A negative electrode active material according to one or more embodiments may include a core including a silicon-carbon composite, and a coating layer on a surface of the core and including a surfactant and graphene. In an implementation, in an X-ray diffraction analysis using a CuKα ray for the negative electrode active material, a ratio (I_{second peak}/I_{first peak}) of an intensity of a second peak appearing at 2θ=about 45° to about 50° relative to an intensity of a first peak appearing at 2θ=about 25° to about 27° may be about 0.1 to about 0.4, or may be about 0.2 to about 0.3. Maintaining the I_{second peak}/I_{first peak} of the negative electrode active material at about 0.1 to about 0.4 may help prevent deterioration of the cycle-life characteristics and high-rate characteristics.

The negative electrode active material according to some embodiments may include the coating layer including graphene on the surface of the silicon-carbon composite core, which may help suppress the volume expansion of silicon during charging and discharging, and may help improve conductivity. The negative electrode active material according to one or more embodiments may include a well-stacked graphene coating layer, further improving an electrical conductivity.

In the negative electrode active material according to some embodiments, the coating layer may be prepared using the surfactant, thereby allowing it to be positioned very uniformly and effectively covering the surface of the core. The surface of the silicon-carbon composite may be hydrophobic, and may be converted into hydrophilic by using the surfactant, and thus hydrophilic graphene may be well coated on the surface of the silicon-carbon composite.

An amount of the surfactant may be, based on the total weight of the negative electrode active material, e.g., about 0.005 wt % to about 1.05 wt %, about 0.01 wt % to about 1.05 wt %, about 0.1 wt % to about 1.05 wt %, or about 0.2 wt % to about 1.05 wt %.

In an implementation, the surfactant may be a cation surfactant, e.g., dialkyldimethylammonium chloride, in which an alkyl group is a C1 to C3 alkyl group, benzyldimethylammonium chloride, cetyltrimethylammonium bromide, N-methoxy (polyethylene glycol)-1,2-distearoyl-sn-glycero-3-phosphoethanolamine, (mPEG-DSPE), or a combination thereof.

The negative electrode active material according to some embodiments may have a no-extreme increased specific surface area, even though the silicon-carbon composite core is coated with the graphene.

The specific surface area of the negative electrode active material may be about 130% or less relative to or of the specific surface area of the silicon-carbon composite, e.g., greater than about 100% and about 130% or less, about 110% to about 130%, or about 120% to about 130%. The specific surface area of the negative electrode active material, which falls into the range corresponding to the specific surface area of the core, may imply that the graphene on the surface exists as a thin layer, e.g., at a thickness of about 1 nm to about 20 nm.

The negative electrode active material according to some embodiments may include graphene on its surface as a thin layer, which may help effectively diffuse lithium ions, thereby improving electrical conductivity and effectively securing the lithium ion diffusion path.

The term graphene refers to a material with a plate-like structure, e.g., a plate in which carbons are connected, and multiple such plates may be stacked to form graphite which is crystalline carbon. Graphene may indicate a form in which 8 to 15 plates are stacked, e.g., and may be a form in which 1 to 3 plates are stacked.

The graphene present on the surface of the negative electrode active material according to one or more embodiments may be a stacked form in which 1 to 3 plates are stacked for one or a single coating, or a graphene in which 3 to 9 plates are stacked for three coatings. In an implementation, as described in above, the number of stacked plates or layers of graphene may be appropriately adjusted, and the electrical conductivity and lithium ion diffusion speed may be further enhanced. Graphene may have a thin form in which 1 to 3 plates are stacked, and the several coatings may substantially, completely, and uniformly cover the silicon-carbon composite. If graphene in which 8 to 15 plates are stacked were to be used, it could be non-uniformly coated on the silicon-carbon composite, thereby deteriorating battery performances and electrochemical characteristics.

The graphene according to some embodiments may be an exfoliated graphene, and may be prepared by electrochemically exfoliating crystalline carbon. The exfoliation may be performed by adding a crystalline carbon first electrode and a metal second electrode to a persulfate electrolyte and applying an electric field thereto. The crystalline carbon may include natural graphite, artificial graphite, or a combination thereof and the metal may include aluminum, iron, potassium, magnesium, sodium, nickel, platinum, or a combination thereof. The persulfate electrolyte may include sodium persulfate, potassium persulfate, ammonium persulfate, or a combination thereof. The molar concentration thereof may be, e.g., about 0.1 M to about 5 M. A voltage of the electric field may be, e.g., about 10 V to about 100 V.

In an implementation, the negative electrode active material according to one embodiment may be used together with a crystalline carbon negative electrode active material, the surface contact with the neighboring crystalline carbon negative electrode active material may be improved, and the isolation of the active material that occurs during charging and discharging may be suppressed, so that the charging and discharging characteristics and the cycle-life characteristics may be more improved.

The silicon-carbon composite could generate a SEI (Solid Electrolyte Interface) film which is formed by reacting it with an electrolyte during charge and discharge to deteriorate the cycle-life characteristics. However, the negative electrode active material according to one embodiment may include the graphene on the surface thereof, and thus, the reaction with the electrolyte during charging and discharging may be prevented, thereby improving the cycle-life characteristics. The volume expansion of silicon may be effectively suppressed, and thus, the mechanical strength may be secured.

In an implementation, an amount of graphene may be, e.g., based on the total weight of the negative electrode active material, about 1 wt % to about 10 wt %, about 1 wt % to about 8 wt %, or about 1 wt % to 7 wt %. Maintaining the amount of graphene within the ranges may help ensure that the volume expansion may be effectively suppressed and the cycle-life characteristic may be further enhanced.

In an implementation, the silicon-carbon composite may have a porous structure. The silicon-carbon composite may include nano silicon and an amorphous carbon, or an agglomerated product in which nano silicon and an amorphous carbon may be agglomerated. In an implementation, the silicon-carbon composite may include an agglomerated product which is a secondary particle in which nano silicon, e.g., primary particles of silicon nanoparticles are agglomerated and amorphous carbon filled between the agglomerated product which may be positioned by surrounding a surface of the primary particles or which may be positioned by surrounding a surface of the agglomerate product, the secondary particle. The negative electrode active material according to some embodiments may have a porous structure with spaces, e.g., pores, between the agglomerated products.

The amorphous carbon may include, e.g., soft carbon, hard carbon, mesophase, pitch carbide, sintered cokes, or combinations thereof.

In the silicon-carbon composite, a mixing (e.g., weight) ratio of nano silicon and the amorphous carbon may be, e.g., about 70:30 to about 40:60, or about 65:35 to about 40:60.

### <Preparation of Negative Electrode Active Material>

The negative electrode active material according to some embodiments may be prepared by mixing the silicon-carbon composite, graphene, and a surfactant to prepare a mixture, and then heat-treating the mixture. Hereinafter, each step will be described in more detail.

The graphene may be prepared by exfoliating graphite using an electrochemical method.

The graphene and the surfactant may be mixed in a solvent to prepare a graphene mixed liquid. The solvent may be water. In an implementation, the mixing may be carried out by adding the graphene to the solvent to prepare a graphene liquid, and adding the surfactant to the graphene liquid.

The surfactant may be a cation surfactant, e.g., dialkyldimethylammonium chloride, in which an alkyl group may be a C1 to C3 alkyl group, benzyldimethylammonium chloride, cetyltrimethylammonium bromide, N-methoxy (polyethylene glycol)-1,2-distearoyl-sn-glycero-3-phosphoethanolamine (mPEG-DSPE), or a combination thereof.

The cation ion surfactant may be water-soluble and may be appropriately used in an aqueous system.

In the mixing, the anion functional group included in the graphene may be bonded with the cation functional group included in the head of the surfactant through an electrical attractive force.

In the mixing, the amount of the surfactant may be, e.g., about 1 part by weight to about 30 parts by weight, about 5 parts by weight to about 30 parts by weight, or about 10 parts by weight to about 30 parts by weight, based on 100 parts by weight of the graphene. Maintaining the amount of the surfactant within the ranges may help ensure that the bonding between the graphene and the surfactant may be effectively and sufficiently realized.

A coating may be performed by coating the silicon-carbon composite with the graphene mixed liquid. In the coating, the silicon-carbon composite may be used as a liquid by adding it to a solvent. The solvent may be, e.g., an organic solvent such as ethanol or isopropyl alcohol, water, or a combination thereof.

In the coating, the hydrophobic tail of the surfactant may be bonded to the silicon-carbon composite through an electrical attractive force. Thus, the silicon-carbon composite and graphene may be firmly bonded via the surfactant, thereby stably positioning the coating layer including the graphene on the silicon-carbon composite.

The coating may be carried out by admixing the silicon-carbon composite to the graphene mixed liquid, and drying.

An amount of the graphene may be, e.g., based on 100 parts by weight of the silicon carbon composite, about 0.5 parts by weight to about 7 parts by weight, about 1 part by weight to about 5 parts by weight, or about 1.5 parts by weight to about 2 parts by weight.

The mixing may be carried out at room temperature, e.g., about 20° C. to about 28° C.

After mixing, a washing may be further performed. The washing may be performed by using an organic solvent, e.g., methanol, ethanol, propanol, isopropyl alcohol, or a combination thereof.

The drying may be carried out on the solid obtained by separating the product after the mixing and washing. The separation may be carried out by a suitable procedure that may separate the product from the solvent to obtain the solids, e.g., by centrifugation. In an implementation, the centrifugation may be carried out at a rotation speed of, e.g., about 500 rpm to about 4,000 rpm, or about 1,000 rpm to about 4,000 rpm.

The drying may be carried out at about 50° C. to about 100° C., or about 60° C. to about 90° C.

In an implementation, the coating may be performed once to about five times, e.g., about two times to about five times, or about three times to about five times. Performing the coating 2 to 5 times may help ensure that the coating layer including the graphene may better cover the surface of the silicon-carbon composite core, resulting in increased overall coverage. An amount of the graphene included in the negative electrode active material may be about 1 wt % to about 10 wt %, based on the total weight of the negative electrode active material.

The coating may be performed 1 to 5 times, e.g., 2 to 5 times, which may result in the stacking of graphene to form a multi-layer structure, and this may be confirmed by an increase in an intensity of peak of graphitic carbon through an X-ray analysis. This increase in the peak intensity may be effectively demonstrated by using surfactant. The graphene may be included in the coating layer in the form of the multi-layer structure, thereby increasing uniformity of the surface of the active material and inhibiting the side reaction between the silicon and the electrolyte.

The product obtained from coating may be heat-treated. The heat-treatment may be performed at about 600° C. to about 1,000° C., or about 800° C. to about 1,000° C., and may be performed for about 1 hour to about 10 hours, or about 1 hour to about 5 hours. Maintaining the temperature of the heat treatment within the ranges may help ensure that the contact between the graphene and the silicon-carbon composite may be firmed and may help prevent the silicon crystal from being extremely increased. The heat-treatment may be performed under an inert atmosphere. In an implementation, the heat treatment may be performed under an atmosphere that includes, e.g., N₂, argon, helium, or combinations thereof. In an implementation, the heat-treatment may be performed under the described atmosphere, and the oxidization of silicon or the generation of SiC may be prevented in the heat-treatment.

In the heat-treatment, the remaining surfactant which is not bonded to the silicon-carbon composite may be carbonized and the carbonized product may help enhance the conductivity of the negative electrode active material.

According to the heat-treatment, graphene may be firmly and closely positioned on the silicon-carbon composite and the increase in the specific surface area of the final negative electrode active material may be suppressed, so that the effects using graphene may be well obtained.

If the heat-treatment were not performed, due to the use of graphene, the specific surface area of the negative electrode active material could surprisingly increase, leading to an inappropriate increase in the reaction with the electrolyte during charging and discharging, and the low bonding strength between the silicon-carbon composite and graphene may be unable to sufficiently suppress the volume expansion of silicon. The improvement in conductivity due to the carbonization of the surfactant may not be realized.

### <Rechargeable Lithium Battery>

According to one or more embodiments, a rechargeable lithium battery including a negative electrode, a positive electrode, and an electrolyte, may be provided.

Another embodiment provides a rechargeable lithium battery including a negative electrode, a positive electrode, and an electrolyte.

The negative electrode may include a current collector and a negative electrode active material layer on the current collector, and may include the negative electrode active material according to one or more embodiments.

The negative electrode active material according to one or more embodiments may be included as a first negative electrode active material, and crystalline carbon may be included as a second negative electrode active material. A mixing (e.g., weight) ratio of the first negative electrode active material and the second negative electrode active material may be about 20:80 to about 10:90. In an implementation, the negative electrode active material may include the first negative electrode active material and the second negative electrode active material at a weight ratio of about 18:82 to about 12:88.

In the negative electrode active material layer, the amount of the negative electrode active material may be about 95 wt % to about 98 wt %, based on the total weight of the negative electrode active material layer.

In an implementation, negative electrode active material layer may include a binder or a conductive material. In the negative electrode active material layer, an amount of the binder may be about 1 wt % to about 5 wt %, based on the total weight of the negative electrode active material layer. An amount of the conductive material may be about 1 wt % to about 5 wt %, based on the total weight of the negative electrode active material layer.

The binder may facilitate attachment of the negative electrode active material particles to each other and may also facilitate attachment the negative electrode active material to the current collector. The binder may be a non-aqueous binder, an aqueous binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, a (meth)acryl rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, or a combination thereof.

The binder may include a cellulose compound, and this cellulose compound may be used together with the aqueous binder. The cellulose compound may include, e.g., carboxymethyl cellulose, hydroxypropylmethyl cellulose, methyl cellulose, or alkali metal salts thereof. The alkali metal may be, e.g., Na, K, or Li. The cellulose compound may serve as a binder or as a thickener that may impart viscosity. The cellulose compound may be used in a suitable amount within the amount of the binder, e.g., about 0.1 parts by weight to about 3 parts by weight based on 100 parts by weight of the negative electrode active material.

The binder may include a dry binder, e.g., a polymer material that is capable of being fibrous. In an implementation, the dry binder may include polytetrafluoroethylene, polyvinylidene fluoride, a polyvinylidene fluoride-hexafluoropropylene copolymer, polyethyleneoxide, or a combination thereof.

The conductive material may be included to provide electrode conductivity, and a suitable electrically conductive material that does not cause a chemical change may be used. Examples of the conductive material may include a carbon material such as natural graphite, artificial graphite, carbon black, acetylene black, ketjen black, a carbon fiber, a carbon nanofiber, carbon nanotube, or the like; a metal material of a metal powder or a metal fiber including copper, nickel, aluminum, silver, and the like; a conductive polymer such as a polyphenylene derivative; or a mixture thereof.

The current collector may include a copper foil, a nickel foil, a stainless steel foil, a titanium foil, a nickel foam, a copper foam, a polymer substrate coated with a conductive metal, or a combination thereof.

### [Positive Electrode]

The positive electrode may include a current collector and a positive electrode active material layer on the current collector.

The positive electrode active material layer may include a positive electrode active material and may further include a binder or a conductive material. In an implementation, the positive electrode may further include an additive that may serve as a sacrificial positive electrode.

The positive electrode active material may include lithiated intercalation compounds that reversibly intercalate and deintercalate lithium ions. In an implementation, a composite oxide of lithium and a metal, e.g., cobalt, manganese, nickel, or combinations thereof, may be used.

The composite oxide may be a lithium transition metal composite oxide, and examples thereof may include lithium nickel oxide, lithium cobalt oxide, lithium manganese oxide, lithium iron phosphate compound, cobalt-free nickel-manganese oxide, or a combination thereof.

In an implementation, the following compounds represented by any one of the following chemical formulas may be used. LiₐA_{1-b}X_{b}O_{2-c}D′_{c} (0.90≤a≤1.8, 0≤b≤0.5, 0≤c≤0.05); LiₐMn_{2-b}X_{b}O_{4-c}D′: (0.90≤a≤1.8, 0≤b≤0.5, 0≤c≤0.05); LiₐNi_{1-b-c}CO_{b}X_{c}O_{2-α}D′_{α} (0.90≤a≤1.8, 0≤b≤0.5, 0≤c≤0.5, 0<α<2); LiₐNi_{1-b-c}Mn_{b}X_{c}O_{2-α}D′_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A may be, e.g., Ni, Co, Mn, or a combination thereof; X may be, e.g., Al, Ni, Co, Mn, Cr, Fe, Mg, Sr, V, a rare earth element or a combination thereof; D′ may be, e.g., O, F, S, P, or a combination thereof; G may be, e.g., Al, Cr, Mn, Fe, Mg, La, Ce, Sr, V, or a combination thereof; and L¹ may be, e.g., Mn, Al, or a combination thereof.

In an implementation, the positive electrode active material may be may be a high nickel positive electrode active material having a nickel amount of greater than or equal to about 80 mol %, greater than or equal to about 85 mol %, greater than or equal to about 90 mol %, greater than or equal to about 91 mol %, or greater than or equal to about 94 mol % and less than or equal to about 99 mol %, based on 100 mol % of the metal excluding lithium in the lithium transition metal composite oxide. The high-nickel positive electrode active material may help realize high capacity and may be applied to a high-capacity, high-density rechargeable lithium battery.

In the positive electrode, an amount of the positive electrode active material may be about 90 wt % to about 98 wt %, based on the total weight of the positive electrode active material layer. The binder and the conductive material may be included in an amount of about 1 wt % to about 5 wt %, respectively based on the total weight of the positive electrode active material layer.

The binder may help improve binding properties of positive electrode active material particles with one another and with a current collector. Examples of the binder may include polyvinyl alcohol, carboxymethyl cellulose, hydroxypropyl cellulose, diacetylcellulose, polyvinyl chloride, carboxylated polyvinylchloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, epoxy resin, a (meth)acryl resin, polyester resin, nylon, or the like.

The conductive material may be included to provide electrode conductivity, and a suitable electrically conductive material that does not cause a chemical change may be used. Examples of the conductive material may include a carbon material such as natural graphite, artificial graphite, carbon black, acetylene black, ketjen black, a carbon fiber, a carbon nanofiber, carbon nanotube, or the like; a metal material of a metal powder or a metal fiber including copper, nickel, aluminum, silver, or the like; a conductive polymer such as a polyphenylene derivative; or a mixture thereof.

The current collector may include, e.g., Al.

### [Electrolyte]

The electrolyte may include a non-aqueous organic solvent and a lithium salt.

The non-aqueous organic solvent may serve as a medium for transmitting ions taking part in the electrochemical reaction of a battery.

The non-aqueous organic solvent may include a carbonate, ester, ether, ketone, alcohol, aprotic, or a combination thereof.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include methyl acetate, ethyl acetate, n-propyl acetate, dimethyl acetate, methyl propionate, ethyl propionate, decanolide, mevalonolactone, valerolactone, caprolactone, or the like. The ether solvent may include dibutyl ether, tetraglyme, diglyme, dimethoxyethane, 2-methyltetrahydrofuran, 2,5-dimethyltetrahydrofuran, tetrahydrofuran, or the like. The ketone solvent may include cyclohexanone, or the like. The alcohol solvent may include ethanol, isopropyl alcohol, or the like. The aprotic solvent may include nitriles such as R-CN (wherein R is a C2 to C20 linear, branched, or cyclic hydrocarbon group, and may include a double bond, an aromatic ring, or an ether bond, or the like); amides such as dimethylformamide; dioxolanes such as 1,3-dioxolane, 1,4-dioxolane, and the like; sulfolanes, or the like.

The non-aqueous organic solvents may be used alone or in combination of two or more.

In an implementation, a carbonate solvent may be used, a cyclic carbonate and a chain carbonate may be mixed and used, and the cyclic carbonate and the chain carbonate may be mixed in a volume ratio of about 1:1 to about 1:9.

The lithium salt dissolved in the organic solvent may supply lithium ions in a battery, may enable a basic operation of a rechargeable lithium battery, and may help improve transportation of the lithium ions between positive and negative electrodes. Examples of the lithium salt may include LiPF₆, LiBF₄, LiSbF₆, LiAsF₆, LiClO₄, LiAlO₂, LiAlCl₄, LiPO₂F₂, LiCI, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂) (C_{y}F_{2y+1}SO₂) (wherein x and y are integers of 1 to 20), lithium trifluoromethane sulfonate, lithium tetrafluoroethane sulfonate, lithium difluorobis(oxalato)phosphate (LiDFOB), and lithium bis(oxalato) borate (LiBOB).

### [Separator]

Depending on the type of the rechargeable lithium battery, a separator may be present between the positive electrode and the negative electrode. The separator may include polyethylene, polypropylene, polyvinylidene fluoride, or a multilayer film of two or more layers thereof, or a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of, e.g., polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride polymer or a (meth)acrylic polymer.

The inorganic material may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The organic material and the inorganic material may be mixed in one coating layer, or a coating layer including an organic material and a coating layer including an inorganic material may be stacked.

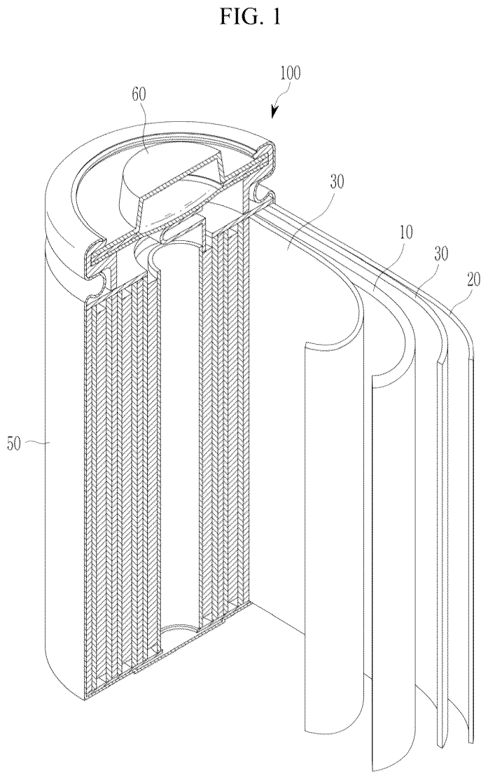

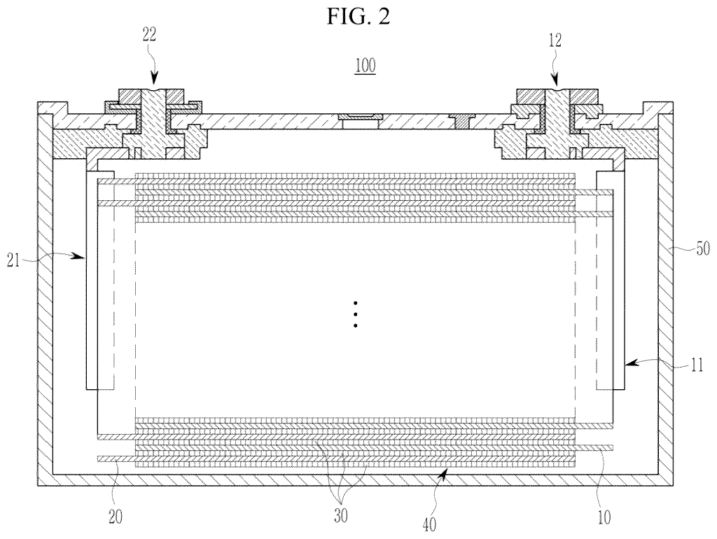

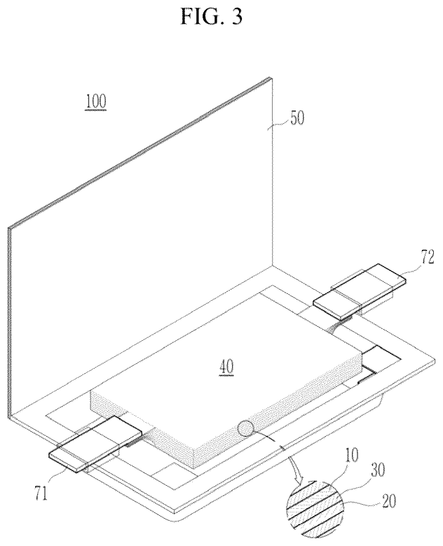

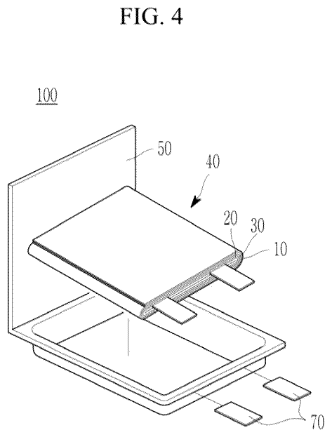

The rechargeable lithium battery may be classified into cylindrical, prismatic, pouch, or coin-type batteries, or the like depending on their shape. FIG. 1 to FIG. 4 are schematic views illustrating a rechargeable lithium battery according to an embodiment. FIG. 1 shows a cylindrical battery, FIG. 2 shows a prismatic battery, and FIG. 3 and FIG. 4 show pouch-type batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. The rechargeable lithium battery 100 may include a sealing member 60 sealing the case 50, as shown in FIG. 1. In FIG. 2, the rechargeable lithium battery 100 may include a positive lead tab 11, a positive terminal 12, a negative lead tab 21, and a negative terminal 22. As shown in FIG. 3 and FIG. 4, the rechargeable lithium battery 100 may include an electrode tab 70, which may be, e.g., a positive electrode tab 71 and a negative electrode tab 72 serving as an electrical path for inducing the current formed in the electrode assembly 40 to the outside.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

Graphene was added to a distilled water and dispersed to prepare a graphene liquid with a concentration of 1.1 wt %. As the graphene, a product in which an artificial graphite first electrode and a platinum second electrode were added to sodium persulfate electrolyte and a voltage of 10 V was applied thereto, was used.

Cetyltrimethylammonium bromide was added to the graphene liquid to prepare a graphene mixed liquid. Cetyltrimethylammonium bromide was used at an amount of 15 wt %, based on a total weight of graphene.

1 g of a silicon-carbon composite and 2 g of ethanol were mixed in a conical tube to prepare a silicon-carbon composite liquid.

The silicon-carbon composite used was a soft carbon coating layer on an agglomerated product in which silicon nanoparticles having an average particle diameter, D50 of 100 nm and soft carbon were agglomerated. Based on the total weight of the silicon-carbon composite, an amount of the silicon nanoparticles was 54 wt % and an amount of the soft carbon was 46 wt %.

Thereafter, the silicon-carbon composite was coated with graphene. The coating was performed once.

The coating was performed by adding the graphene mixed liquid to the silicon-carbon composite liquid in order to have 1.65 parts by weight of graphene based on 100 parts by weight of the silicon-carbon composite, mixing, washing, separating, and drying. The mixing was conducted at ambient temperature, using a vortex mixer for 1 minute. The washing was performed by adding ethanol, and the separating was performed by centrifuging at a speed of 3,000 rpm. The drying was performed at 80° C.

The obtained dried product was heat-treated at 900° C. under an argon atmosphere for 3 hours to prepare a negative electrode active material. The prepared negative electrode active material included the silicon-carbon composite coated with the coating layer including the surfactant and graphene, and an amount of surfactant was 0.25 wt %, based on the total weight of the negative electrode active material and an amount of graphene was 1.65 wt %.

The negative electrode active material was used as a first negative electrode active material and natural graphite was used as a second negative electrode active material. The first negative electrode active material and the second negative electrode active material were mixed at a weight ratio of 13.5:86.5 to prepare a composite negative electrode active material. The composite negative electrode active material, a styrene-butadiene rubber binder and carboxymethyl cellulose thickener were mixed at a weight ratio of 97.5:1.5:1 in a water solvent to prepare a negative electrode active material layer slurry.

The negative electrode active material slurry was coated on a Cu foil current collector, dried, and pressed to prepare a negative electrode including the current collector and a negative electrode active material layer formed on the current collector. The prepared negative electrode active material layer had a loading level of 6.8 mg/cm² and active mass (referred to as a negative electrode active material layer) density of 1.6 g/cm³.

The negative electrode, a lithium metal counter electrode, and an electrolyte were used to fabricate a half-cell. As the electrolyte, a 1.5 M LiPF₆ solution in a mixed solvent of ethylene carbonate, ethylmethyl carbonate, and dimethyl carbonate (20:10:70 volume ratio) was used.

### Example 2

A negative electrode active material was prepared by the same procedure as in Example 1, except that the coating was performed twice. The prepared negative electrode active material included the silicon-carbon composite coated with the coating layer including the surfactant and graphene, and an amount of surfactant was 0.5 wt %, based on the total weight of the negative electrode active material, and an amount of graphene was 3.3 wt %.

The negative electrode active material was used as a first negative electrode active material to fabricate a negative electrode and a half-cell by the same procedure as in Example 1.

### Example 3

A negative electrode active material was prepared by the same procedure as in Example 1, except that the coating was performed three times. The prepared negative electrode active material included the silicon-carbon composite coated with the coating layer including the surfactant and graphene, and an amount of surfactant was 0.75 wt %, based on the total weight of the negative electrode active material, and an amount of graphene was 4.95 wt %.

The negative electrode active material was used as a first negative electrode active material to fabricate a negative electrode and a half-cell by the same procedure as in Example 1.

### Example 4

A negative electrode active material was prepared by the same procedure as in Example 1, except that the coating was performed four times. The prepared negative electrode active material included the silicon-carbon composite coated with the coating layer including the surfactant and graphene, and an amount of surfactant was 1 wt %, based on the total weight of the negative electrode active material, and an amount of graphene was 6.6 wt %.

The negative electrode active material was used as a first negative electrode active material to fabricate a negative electrode and a half-cell by the same procedure as in Example 1.

### Example 5

A negative electrode active material was prepared by the same procedure as in Example 3 except that N-methoxy (polyethylene glycol)-1,2-distearoyl-sn-glycero-3-phosphoethanolamine (mPEG-DSPE) was used as a surfactant. The prepared negative electrode active material included the silicon-carbon composite coated with the coating layer including the surfactant and graphene, and an amount of surfactant was 0.75 wt %, based on the total weight of the negative electrode active material, and an amount of graphene was 4.95 wt %.

The negative electrode active material was used as a first negative electrode active material to fabricate a negative electrode and a half-cell by the same procedure as in Example 3.

### Example 6

A negative electrode active material was prepared by the same procedure as in Example 3, except that cetyltrimethylammonium bromide was used at an amount of 30 wt %, based on a total weight of graphene. The prepared negative electrode active material included the silicon-carbon composite coated with a coating layer including the surfactant and graphene and an amount of the amount of the surfactant was 0.75 wt %, based on the total weight of the negative electrode active material, and an amount of graphene was 4.95 wt %.

The negative electrode active material was used as a first negative electrode active material to fabricate a negative electrode and a half-cell by the same procedure as in Example 3.

### Comparative Example 1

The silicon-carbon composite used in Example 1 was used as a negative electrode active material to prepare a negative electrode. The negative electrode was used to fabricate a negative electrode and a half-cell by the same procedure as in Example 3.

### Comparative Example 2

A negative electrode active material was prepared by the same procedure as in Example 3, except that no heat-treatment was carried out at 900° C. The prepared negative electrode active material included a silicon-carbon composite coated with a coating layer including the surfactant and graphene, and an amount of the surfactant was 0.75 wt %, based on the total weight of the negative electrode active material, and an amount of graphene was 4.95 wt %.

The negative electrode active material was used as the first negative electrode active material to fabricate a negative electrode and a half-cell by the same procedure as in Example 3.

### Comparative Example 3

A negative electrode active material was prepared by the same procedure as in Example 3, except that the graphene liquid of Example 3 was coated on the silicon-carbon composite. That is, the surfactant was not used. The negative electrode active material was used as the first negative electrode active material to fabricate a negative electrode and a half-cell by the same procedure as in Example 1.

### Experimental Example 1) Evaluation of SEM

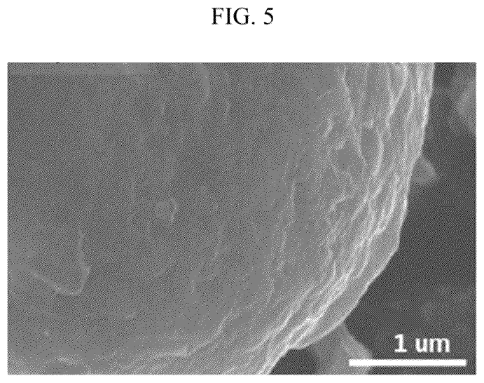

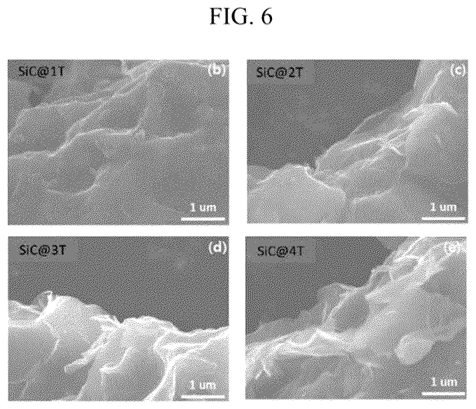

SEM images of the negative electrode active materials of Comparative Example 1 and Examples 1 to 4 are respectively shown in FIG. 5 and FIG. 6. Part (b) of FIG. 6 is a result of Example 1 in which the number of coatings was 1 (1T), part (c) of FIG. 6 is a result of Example 2 in which the number of coatings is 2 (2T), part (d) of FIG. 6 is a result of Example 3 in which the number of coatings was 3 (3T), and part (e) of FIG. 6 is a result of Example 4 in which the number of coatings was 4 (4T).

As shown in FIG. 5, the negative electrode active material prepared by Comparative Example 1 had a uniform amorphous carbon surface. Regarding this, from part (b) of FIG. 6 where the coating was carried out once, part (c) of FIG. 6 where the coating was carried out twice, (d) of FIG. 6 where the coating was carried out three times, and part (e) of FIG. 6 where the coating was carried out four times, it may be seen that the surface of the amorphous carbon had wiggle (e.g., an irregular or undulating surface) due to graphene coating. In Example 1, the coating was carried out once, and there were some areas where the surface roughness appears to be high due to small graphene amount. As the number of coatings increased, it may be seen that the coating was well applied on the surface without any exposed areas.

### Experimental Example 2) Evaluation of X-Ray Diffraction Characteristic

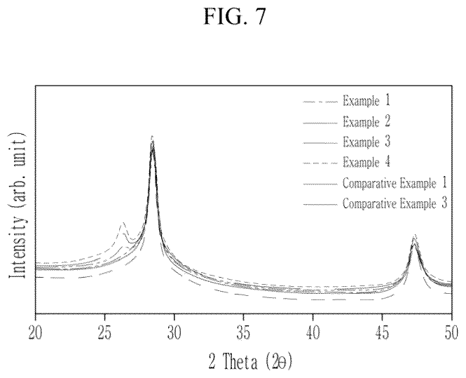

The negative electrode active materials of Examples 1-6 and Comparative Examples 1 to 3 were evaluated regarding an X-ray diffraction pattern using a CuKα ray. Some of the results are shown in FIG. 7. From the results, a ratio (I_{second peak}/I_{first peak}) of the second peak intensity appearing at 2 θ=25° to 27° relative to the first peak intensity appearing at 2 θ=45° to 50° was calculated. The results are shown in Table 1.

As shown in FIG. 7, in Comparative Examples 1 and 3, a diffraction pattern of graphitic carbon relative to graphene did not appear, i.e., the first peak did not appear at 2θ=25° to 27°. Examples 1 to 4 showed the first peak at 2θ=25° to 27° and the intensity of the first peak increased proportionally as the number of coatings of graphene increased.

From the results in FIG. 7 and Table 1, it may be seen that graphene was well stacked according to the number of coatings.

### Experimental Example 3) Conductivity Characteristic

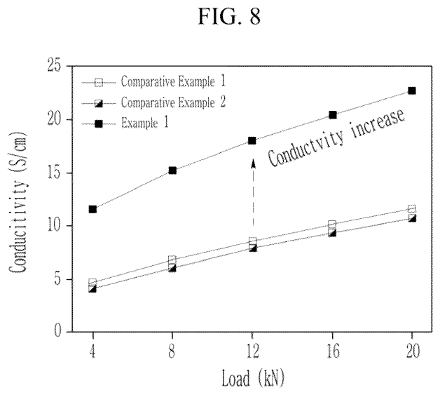

The powder conductivity of the negative electrode active materials of Example 1, and Comparative Examples 1 and 2 were measured. The results are shown in FIG. 8. The powder conductivity was measured by pouring 10 g of the negative electrode active material into a vessel and pressurizing for 1 minute at each pressure while changing the pressurized pressure. The conductivity according to a pressurized pressure was measured. The results are shown in FIG. 8.

As shown in FIG. 8, Example 1, which used the surfactant and underwent heat treatment to coat graphene, exhibited better conductivity than Comparative Example 1, which did not include coated graphene. Comparative Example 2, even though graphene was coated using the surfactant, but without heat-treatment, exhibited similar conductivity to Comparative Example 1, which did not have a graphene coating.

### Experimental Example 4) Evaluation of Capacity Retention

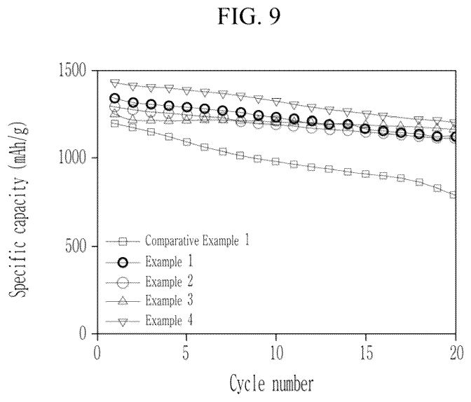

The half-cells of Examples 1 to 4 and Comparative Example 1 were subjected to a formation process at 25° C., by charging at 0.05 C and discharging at 0.1 C in a voltage window of 0.005 V to 1.5 V and charged at 0.2 C and discharged at 0.5 C for 20 cycles to evaluate cycle-life test. The discharge capacity was obtained at each cycle. The results are shown in FIG. 9 and Table 1.

As shown in FIG. 9 and Table 1, Examples 1 to 4 exhibited excellent cycle-life characteristics than Comparative Example 1.

### Experimental Example 5) Evaluation of High-Rate Characteristic

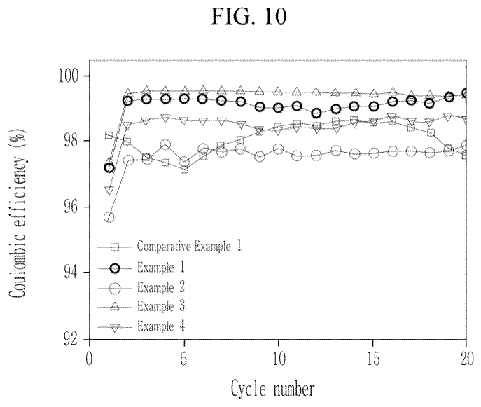

The half-cells of Examples 1 to 4 and Comparative Example 1 were subjected to a formation test by the same procedure as in Experimental Example 4, and then charged and discharged at 0.2 C for five cycles, charged and discharged at 0.5 C for five cycles, charged and discharged at 1 C for five cycles, and charged and discharged at 2 C for five cycles, and charged and discharged at 0.2 C for five cycles, at 25° C. The discharge capacity at each C-rate was measured. The results are shown in FIG. 10 and Table 1.

It may be seen from FIG. 10 and Table 1, the high-rate characteristics of Examples 1 to 4 were superior to that of Comparative Example 1.

TABLE 1

| | | | Evaluation of High- |
|---|---|---|---|
| | | Cycle-life | rate characteristic |
| | I_{second peak}/ | retention at | 2 C retention relative |
| | I_{first peak} | 20 cycles (%) | to 0.2 C (%) |
| Example 1 | 0.17 | 83.5 | 78.1 |
| Example 2 | 0.20 | 86.3 | 83.8 |
| Example 3 | 0.29 | 93.5 | 87.3 |
| Example 4 | 0.37 | 84.2 | 82.9 |
| Example 5 | 0.19 | 85.9 | 83.0 |
| Example 6 | 0.19 | 86.1 | 83.9 |
| Comparative | 0 | 66.6 | 70.0 |
| Example 1 | | | |
| Comparative | 0.02 | 72.4 | 72.1 |
| Example 2 | | | |
| Comparative | 0 | 80.5 | 75.4 |
| Example 3 | | | |

As shown in Table 1, the cells of Examples 1 to 6 using the negative electrode active materials having I_{second peak}/I_{first peak} within about 0.1 to about 0.4 exhibited excellent cycle-life retention and high-rate characteristic.

The cells of Comparative Examples 1 to 3 (using the negative electrode active material having I_{second peak}/I_{first peak} exceeding about 0.1 to about 0.4) exhibited low cycle-life retention and high-rate characteristic.

One or more embodiments may provide a negative electrode active material capable of improving expansion characteristic and cycle-life characteristic.

A negative electrode active material according to one or more embodiments may exhibit excellent cycle-life characteristics, and small volume expansion during charge and discharge, e.g., excellent volume expansion characteristics.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode active material, comprising:
a core comprising a silicon-carbon composite; and
a coating layer on a surface of the core, the coating layer comprising a surfactant and graphene,
wherein the negative electrode active material has a ratio (I_{second peak}/I_{first peak}) of an intensity of a second peak appearing at 2θ=about 45° to about 50° relative to an intensity of a first peak appearing at 2θ=about 25° to about 27° of about 0.1 to about 0.4, in an X-ray diffraction analysis using a CuKα ray.

2. The negative electrode active material as claimed in claim 1, wherein the I_{second peak}/I_{first peak} is about 0.2 to about 0.3.

3. The negative electrode active material as claimed in claim 1, wherein the surfactant is comprised in an amount of about 0.005 wt % to 1.05 wt %, based on a total weight of the negative electrode active material.

4. The negative electrode active material as claimed in claim 1, wherein the graphene is comprised in an amount of about 1 wt % to about 10 wt %, based on a total weight of the negative electrode active material.

5. The negative electrode active material as claimed in claim 1, wherein a specific surface area of the negative electrode active material is about 130% or less of a specific surface area of the core.

6. The negative electrode active material as claimed in claim 1, wherein a specific surface area of the negative electrode active material is greater than about 100% and about 130% or less of a specific surface area of the core.

7. The negative electrode active material as claimed in claim 1, wherein the silicon-carbon composite has a porous structure.

8. The negative electrode active material as claimed in claim 1, wherein the silicon-carbon composite comprises nano silicon and amorphous carbon.

9. The negative electrode active material as claimed in claim 8, wherein a mixing ratio of the nano silicon and the amorphous carbon is about 70:30 to about 40:60 by weight.

10. The negative electrode active material as claimed in claim 1, wherein the surfactant comprises a cation surfactant.

11. The negative electrode active material as claimed in claim 1, wherein the surfactant comprises dialkyldimethylammonium chloride, benzyldimethylammonium chloride, cetyltrimethylammonium bromide, N-methoxy (polyethylene glycol)-1,2-distearoyl-sn-glycero-3-phosphoethanolamine, or a combination thereof.

12. The negative electrode active material as claimed in claim 1, wherein the negative electrode active material is prepared by:
mixing the silicon-carbon composite, the graphene, and the surfactant to prepare a mixture, and
heat-treating the mixture.

13. The negative electrode active material as claimed in claim 12, wherein the heat-treating is performed at about 600° C. to about 1,000° C.

14. The negative electrode active material as claimed in claim 1, wherein the negative electrode active material is prepared by:
mixing the graphene and the surfactant in a solvent to prepare a graphene mixed liquid,
coating the silicon-carbon composite with the graphene mixed liquid to prepare a coated product, and
heat-treating the coated product.

15. The negative electrode active material as claimed in claim 14, wherein the coating is performed 1 to 5 times.

16. The negative electrode active material as claimed in claim 14, wherein the heat-treating is performed at about 600° C. to about 1,000° C.

17. A rechargeable lithium battery, comprising:
a negative electrode comprising the negative electrode active material as claimed in claim 1;
a positive electrode comprising a positive electrode active material; and
a non-aqueous electrolyte.

18. The rechargeable lithium battery as claimed in claim 17, wherein the negative electrode comprises the negative electrode active material as a first negative electrode active material and further comprises crystalline carbon as a second negative electrode active material.

19. A method of preparing the negative electrode active material as claimed in claim 1, the method comprising:
mixing the silicon-carbon composite, the graphene, and the surfactant to prepare a mixture, and
heat-treating the mixture.

20. A method of preparing the negative electrode active material as claimed in claim 1, the method comprising:
mixing the graphene and the surfactant in a solvent to prepare a graphene mixed liquid,
coating the silicon-carbon composite with the graphene mixed liquid to prepare a coated product, and
heat-treating the coated product.
